(19) United States
(12) Patent Application Publication
(10) Pub. No.: US 2009/0285369 A1
(43) Pub. Date: Nov. 19, 2009

(54) EMERGENCY NOTIFICATION THROUGH RESERVED NETWORK COMMUNICATION CHANNELS

(75) Inventor: Santosh Subbarayudu Kandala, Hyderabad (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/120,230

(22) Filed: May 13, 2008

(51) Int. Cl. H04M 11/04

(52) U.S. Cl. 379/45

(57) ABSTRACT

A network communication channel can be reserved for emergency notifications. The network communication channel can be a dedicated protocol, port or message identification mechanism that can be recognized by networking software and directed to an emergency notification system that can be operationally associated with an operating system of a computing device. The emergency notification system can cause the computing device to provide appropriate emergency notifications that seek to inform the user without providing detailed, directed instructions that risk being misleading. A centralized emergency notification server can initiate the communications on the reserved communication channel and can direct such communications to computing devices affected by the emergency, which can be selected based on network identifiers associated with affected physical regions.

### BACKGROUND

Traditional emergency notification systems rely on dedicated audio devices to broadcast a tone or message that can inform those within earshot of the existence of an emergency that requires their attention. For example, a traditional fire alarm comprises an audio device that broadcasts a loud undulating tone. To alert those who may have a temporary or permanent hearing impediment, visual indicators, such as strobe lights or other warning lights, have also been a traditional component of emergency notification systems.

As computing devices and networks have become more prevalent, emergency notification systems have incorporated network connectivity, thereby providing a centralized device that can monitor multiple sensors for an emergency and then remotely trigger multiple dedicated emergency notification audio and visual devices. For example, individual smoke detectors can utilize existing network infrastructure to communicate with a centralized server which can then, in turn, utilize the same network infrastructure to trigger network-enabled fire alarms.

In an effort to provide greater information in the event of an emergency, traditional computing devices, such as personal computers, have been communicationally coupled to centralized emergency notification devices such that the personal computer is utilized by the emergency notification network to generate specific escape routes or customized information for a user in the event of an emergency. Such efforts, however, may cause more harm than good, since they place too much responsibility on the computation and processing performed at each local personal computer. For example, determining a customized escape route for a user at each personal computer can provide incorrect information if the location of the personal computer is not precisely known. A user whose personal computer was moved may be provided incorrect information, thereby costing the user precious time in escaping an emergency situation. Similarly, the personal computer may be performing a computationally intensive process when an emergency occurs, and the processing, by that personal computer, to generate a personalized emergency notification may be delayed or improperly performed. If the personal computer is executing an emulated environment, the emergency notification may never even be presented. In addition, the user themselves may not be able to quickly comprehend all of the information being provided by such personal computers even if the processing is based on correct data and is performed in a timely manner, since the user is likely to be distracted by the existence of the emergency itself.

### SUMMARY

A communication channel can be reserved for emergency notifications such that receipt of information, through such a channel, can cause the recipient device to present an emergency notification. In one embodiment, the presented emergency notification can be simplified to provide a cohesive message across multiple computing devices having a range of computational and display capabilities. For example, the presented emergency notification can provide general information, such as an indication of the nature of the emergency and a map illustrating all of the available exits, thereby enabling each individual user to determine their own course of action based on that user's individual circumstances. The presented emergency notification can then be equivalent whether presented on a computationally powerful desktop personal computer, or, conversely, on a computationally weak cellular telephone or television device.

In a further embodiment, the operating system of various computing devices can comprise mechanisms for detecting notifications arriving through the reserved emergency communication channel and responding in a manner appropriate for the computing device. For example, the operating system of a television or smart display could simply stop the display of the current audio/visual programming and could, instead, display a static visual warning notification or could display the visual warning in combination with an appropriate audible notification. Conversely, the operating system of a computing device, such a personal computer, could enter a “safe state”, whereby the computing device's current state can be saved to non-volatile storage, to prevent loss of data, while any processing currently being performed by the computing device can be paused, and a visual notification can be displayed to the user.

In another embodiment, a reserved emergency communication channel can be implemented through a dedicated protocol, a dedicated port on an existing protocol, through predefined headers in messages delivered using existing communication systems, or other appropriate mechanisms. For example, a dedicated protocol can be created that can either be transmitted through existing transmission protocols, or which can act as its own transmission protocol. Alternatively, emergency communications can be transmitted over a dedicated, and previously unreserved, port on an existing transmission protocol, or as messages using an existing messaging protocol, with the messages identified via predefined headers or other identifying information.

In yet another embodiment, the determination of which computing devices should receive an emergency notification can be based on the network address assigned to a computing device. The network addresses assigned to computing devices can be divided such that a range of addresses can be assigned to devices within a particular physical environment, such as a specific building or a particular floor of a building. Emergency notifications can then be delivered to those devices whose network addresses correspond to a physical environment that is determined to be affected by the emergency. Such determinations can be made by an emergency notification server that can be communicationally coupled to relevant information, including dedicated emergency infrastructure, such as alarm systems, and building information.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a diagram of an exemplary system that provides emergency notifications through reserved network communication channels;

FIG. 2 is a block diagram of an exemplary computing device;

FIG. 3 is a layer diagram of an exemplary operating system that provides emergency notifications through reserved network communication channels; and

FIG. 4 is a flow diagram illustrating an exemplary emergency notification system utilizing reserved network communication channels.

### DETAILED DESCRIPTION

The following description relates to providing emergency notifications across multiple types of computing devices utilizing a reserved network communication channel. The reserved network communication channel can be a dedicated protocol, a dedicated port on an existing protocol, messages conforming to a predetermined format delivered through existing protocols, or another appropriate mechanism. An emergency notification server can be communicationally coupled with an emergency detection system, such as an alarm system, and can further be communicationally coupled with other relevant information, such as building systems, maps and the like. The emergency notification server can select one or more computing devices to receive an emergency notification based on the computing devices' network addresses, which can correspond to generalized locations that can be determined, by the emergency notification server, to be impacted by the emergency. Upon receipt of a message utilizing the reserved emergency communication channel, the operating system of the recipient computing device can cause the computing device to provide emergency notifications in a manner appropriate for that computing device.

The techniques described herein focus on, but are not limited to, the recognition, by an operating system, of communications arriving on a reserved emergency communication channel. Indeed, the mechanisms described below are equally implementable by components external to, or subsequently added to, an operating system. Consequently, the references below to operating system components are meant to be illustrative only.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

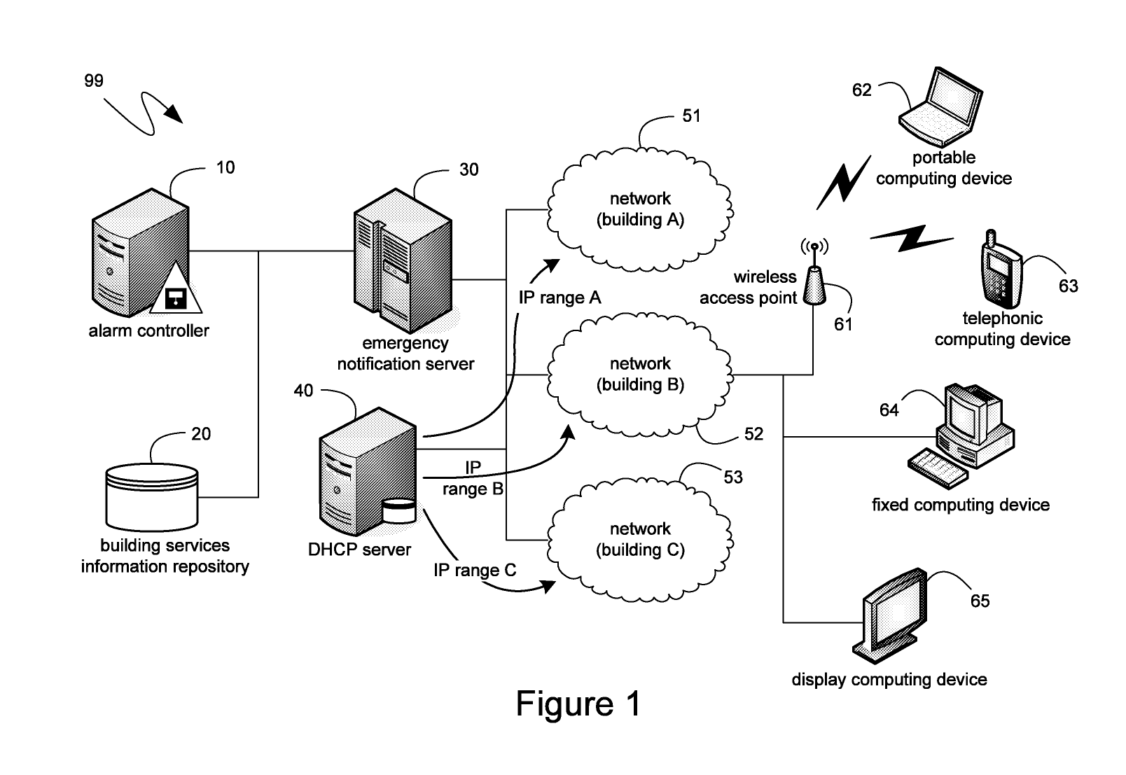

With reference to FIG. 1, an exemplary system 99 is illustrated, comprising, in part, an emergency notification server 30 connected to networks 51, 52 and 53. Each of the networks 51, 52 and 53 can correspond to a particular location, such as a particular building, or floor of a building. For illustrative purposes, FIG. 1 illustrates network 51 as corresponding to a building “A”, network 52 as corresponding to a building “B”, and network 53 as corresponding to building “C”. The exemplary system 99 further comprises computing devices, including portable computing device 62, telephonic computing device 63, a fixed computing device 64 and a display computing device 65, each of which can be communicationally coupled to the emergency notification server 30. In the exemplary system 99, strictly for ease of illustration, the computing devices 62, 63, 64 and 65 are illustrated as being present in building “B”, and, thus, communicationally coupled to the emergency notification server 30 through network 52. Specifically, fixed computing device 64 and display computing device 65 can be communicationally coupled to the network 52 through a wire-based connection, while more mobile computing devices, such as the portable computing device 62 and the telephonic computing device 63 can be communicationally coupled to the network 52 via wireless communications, such as through a wireless base station or access point 61.

In addition to the emergency notification server 30 and the computing devices 62, 63, 64 and 65, the exemplary system 99 can further comprise an alarm controller 10, a building services information repository 20 and a network address assigning device, such as the Dynamic Host Configuration Protocol (DHCP) server 40. In one embodiment, the networks 51, 52 and 53, rather than being separate physical networks can, instead, comprise devices assigned network addresses from discrete groupings of network addresses. For example, the DHCP server 40 can assign Internet Protocol (IP) addresses within one range to those devices in building “A”, within a second range to those devices in building “B”, and a third range to those devices in building “C”. In such a manner, the devices assigned IP addresses, for example, within the first range of values can be thought of as part of network 51, the devices assigned IP addresses within the second range of values can be thought of as part of network 52, and the devices assigned IP addresses within the third range of values can be thought of as part of network 53. Networks 51, 52 and 53 can, therefore, be conceptual concepts based on network addresses, or other identifying information, that can correlate one or more computing devices to a general physical location.

In one embodiment, the emergency notification server 30 can communicate with the computing devices 62, 63, 64 and 65 via a network communication channel reserved for emergency notifications and thereby utilize the computing devices to alert users, and others, of an emergency. The emergency notification server 30 can receive information regarding any emergencies from an alarm controller 10, or other similar emergency detection system. The alarm controller 10 can be any of a number of centralized emergency detection devices that are traditionally communicationally coupled to sensors, manually activated alarm switches, and other alarm and emergency infrastructure. The mechanisms by which the alarm controller 10 determines that an emergency condition exists, and its location or affected area, are not relevant to the present descriptions, so long as such information can be obtained, by the emergency notification server 30, from the alarm controller.

The emergency notification server 30 can be further communicationally coupled to a building services information repository 20, which can include information regarding building services and features. The building services information repository 20 can be any one or more local or remote storage locations and need not be a single centralized source for building information. The building services information repository 20 can provide, to the emergency notification server 30, information regarding the buildings or other physical infrastructure that is protected by the alarm system comprising the alarm controller 10. Such information can include building floor maps, building safety features, such as fire escapes, fire extinguishers, defibrillators, toxic spill treatments, and other like safety features, and other relevant building information. The building services information repository 20 can be utilized by the emergency notification server 30 to identify relevant buildings, or portions of buildings that are affected by the emergency, the location of building safety features relevant to the emergency, and floor maps that may be useful to those in the affected areas.

In one embodiment, to simplify the presentation of information in an emergency, when recipients are not likely to be able to process a lot of information anyway, and to maintain cohesive presentation across multiple computing devices, the emergency notification server 30 can simply provide relevant building services information to the computing devices 62, 63, 64 and 65, and need not tailor the information to a particular user or small groups of users. Thus, the building services information repository 20 can be used to obtain raw information that can then be presented to the computing devices 62, 63, 64 and 65 in a largely unfiltered manner. For example, floor plans, showing the location of relevant building services, such as fire exits or fire extinguishers can be presented without providing user-specific information, such as current location or optimized routes.

Once the emergency notification server 30 has learned of an emergency from the alarm controller 10 and has obtained information regarding the relevant building services from the building services information repository 20, the emergency notification server can identify which computing devices should receive a notification on the communication channel reserved for such emergency notifications. In one embodiment, such a determination can be based on physical locations that can be affected by, or are otherwise relevant to, the emergency, which can be determined by the alarm controller 10 or by the emergency notification server 30 itself, based on the location of the emergency identified by the alarm controller and the building information obtained from the building services information repository 20.

Once the relevant physical locations are identified, the computing devices to which an emergency notification can be sent can be identified by the emergency notification server 30 based on, in one embodiment, their network addresses. In particular, as indicated previously, the DHCP server 40 can provide network addresses, such as IP addresses, within predetermined ranges to computing devices within predetermined locations. While such predetermined ranges can correspond to subnets, there is no requirement that they do, and any identifiable range of network addresses, assigned to any identifiable location, is sufficient for purposes of the mechanisms described. For example, as shown in FIG. 1, if an emergency is determined, by the emergency notification server 30, to affect building “B”, then computing devices 62, 63, 64 and 65 can be identified based on their network addresses as being connected to the network 52 corresponding to the physical location of building “B”. The emergency notification server 30 can, therefore, send an emergency notification using the reserved communication channels to those computing devices.

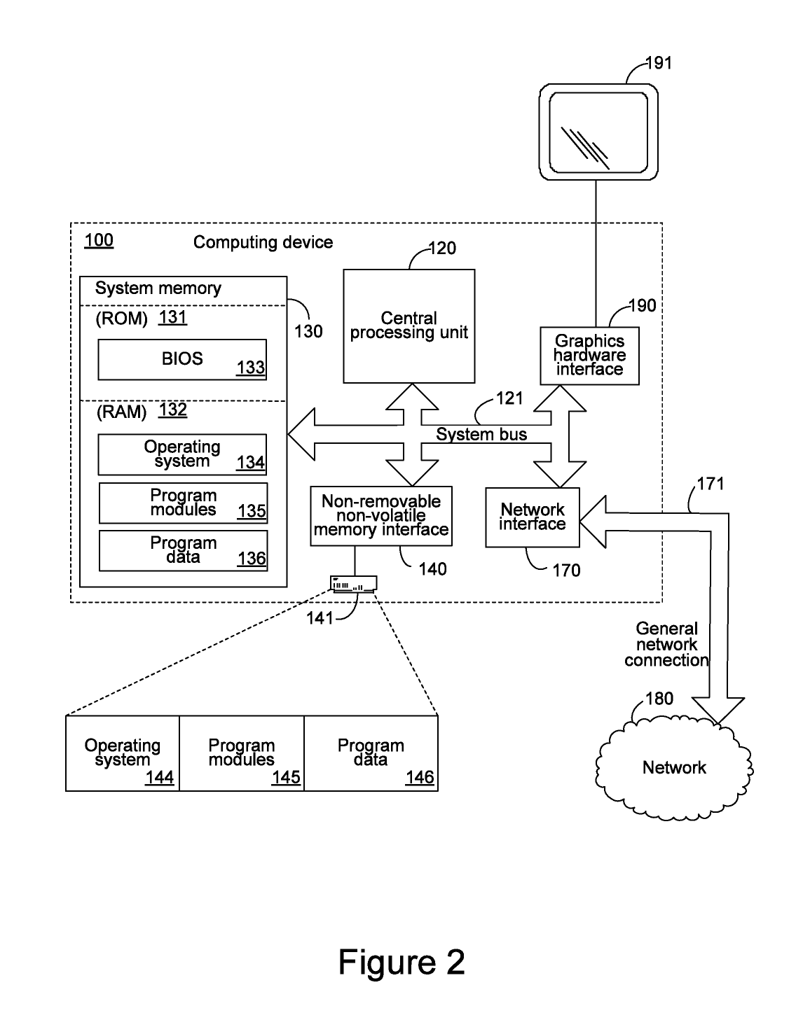

Before turning to a more detailed description of the mechanisms of the communication channel reserved for emergency notifications, and the contemplated responses of the computing devices 62, 63, 64 and 65 upon receiving a notification on such a reserved channel, a more detailed description of an exemplary computing device 100 is provided with reference to FIG. 2. The exemplary computing device 100 described can be any one of the computing devices 62, 63, 64 and 65.

Turning to FIG. 2, the exemplary computing device 100 is illustrated, which can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. The computing device 100 can optionally include graphics hardware, including, but not limited to, a graphics hardware interface 190 and a display device 191.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, other program modules 135, and program data 136.

The computing device 100 may also include other removable/non-removable, volatile/nonvolatile computer storage media. By way of example only, FIG. 2 illustrates a hard disk drive 141 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers hereto illustrate that, at a minimum, they are different copies.

Of relevance to the descriptions below, the computing device 100 may operate in a networked environment using logical connections to one or more remote computers. For example, the computing device 100 is shown in FIG. 2 to be connected to a network 180 via a general network connection 171 that can be a local area network (LAN), a wide area network (WAN) or other network connection. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

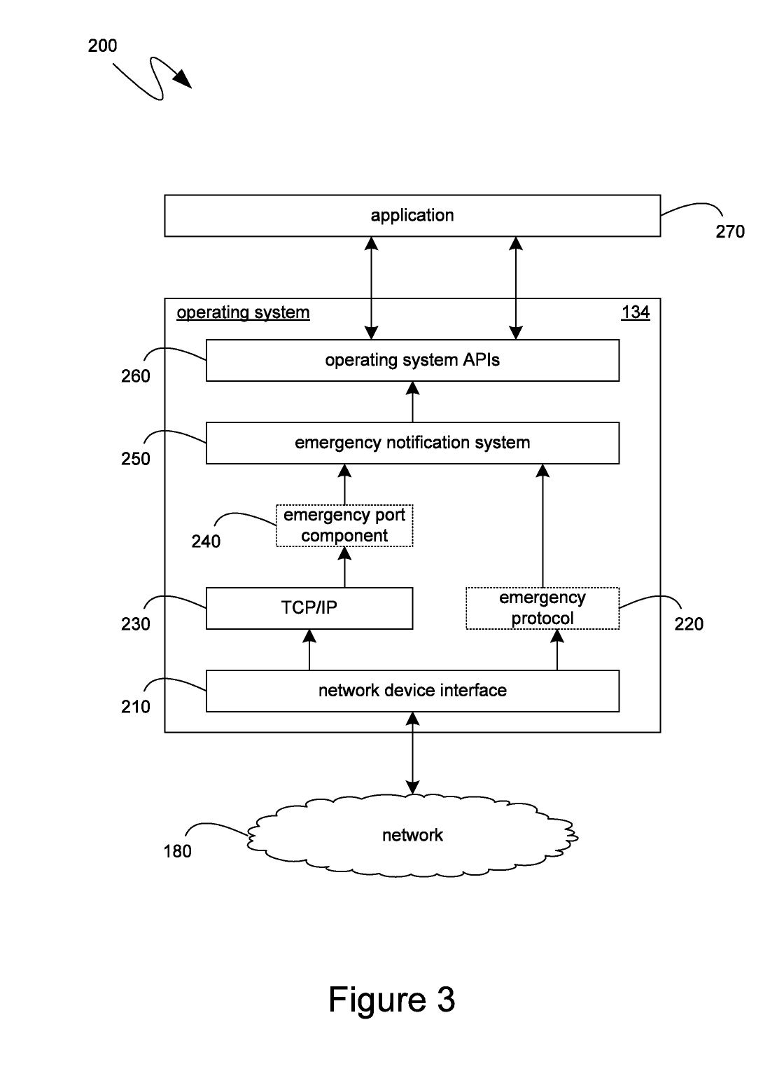

In one embodiment, the network 180 can provide the hardware infrastructure by which emergency notifications can be received by the computing device 100 for presentation via the display 191, as well as any other appropriate aural or visual means. Turning to FIG. 3, contemplated components of the operating system 134 of the exemplary computing device 100 are illustrated in greater detail. As shown, the system 200 of FIG. 3 comprises the operating system 134, an application 270, and the network 180, though, as previously indicated, components illustrated as being elements of the operating system can be equally instantiated as stand-alone components or components of another process, such as the illustrated application, without deviating from their operation, as described below.

The operating system 134 can comprise a network device interface 210, or other driver or collection of drivers, which can be directed to the hardware specifics of receiving communications from, and sending communications to, the network 180. Communications received by the network device interface 210 can be provided to higher level components for further processing in accordance with the protocol by which the communications were received. For example, communications conforming to a specific protocol, such as the ubiquitous Transmission Control Protocol/Internet Protocol (TCP/IP) can be directed to a TCP/IP component 230, which can, as will be known to those skilled in the art, unpack the received communications and provide them to higher level components within the operating system 134, such as the operating system APIs 260, or to applications executing on top of the operating system, such as application 270. In an analogous manner, an emergency protocol component 220 can be utilized to unpack communications received using a protocol reserved for emergency notifications.

In one embodiment, emergency notifications, from the emergency notification server 30 of FIG. 1, can be transmitted using a dedicated emergency protocol that can provide its own syntax, semantics, synchronization of communication, and other protocol-provided aspects of network communications. In such an embodiment, the network device interface 210 can provide communications utilizing the dedicated emergency protocol to the emergency protocol component 220, which can then unpack such communications and present them to higher level components, such as the emergency notification system component 250. The unpacking and other protocol-specific actions performed by the emergency protocol component 220 can conform to whatever protocol specifications are selected, and no particular protocol implementation is required or contemplated by the mechanisms herein described.

In an alternative embodiment, rather than creating a dedicated protocol for the communication of emergency notifications across network 180, an existing protocol, such as the ubiquitous TCP/IP protocols can be used, and the emergency notifications can merely utilize a heretofore unreserved port. As will be recognized by those skilled in the art, some protocols, including TCP/IP, provide the specification of communicational ports within communications conforming to those protocols. A predetermined port can be reserved for emergency notifications, in which case, upon receipt of such communications, the network device interface 210 could, initially, provide them to an appropriate component, such as the TCP/IP component 230, which can then, in turn, after unpacking the communications and performing other protocol-specific actions, provide them to an appropriate handler, such as the emergency port component 240. The emergency port component 240 can then, in turn, provide the communications to the emergency notification system 250. In an alternative embodiment, the TCP/IP component 230 could provide communications specifying the predetermined emergency notification port directly to the emergency notifications system 250.

The emergency protocol component 220 and the emergency port component 240 are illustrated in FIG. 3 with a dashed line to indicate that they are alternatives, though there is no particular aspect of the herein-described mechanisms that would preclude their joint presence. As yet another alternative, rather than relying on a particular protocol or port, emergency notifications can use an existing network communications platform, such as an instant messaging platform, and can simply incorporate a predetermined header or other identifying element within messages conforming to such a communications platform to signify that such messages comprise emergency communications. In such an embodiment, a messaging component or application can initially receive the communications, and can direct emergency communications, identified via the predetermined header or other identifier, to the emergency notification system 250.

The emergency notification system 250 can provide mechanisms by which the operating system 134 can recognize emergency communications as such and can provide to those communications, and any attendant actions, an appropriate level of privilege without requiring external applications, such as application 270, to request such privilege. In particular, the emergency notification system 250 can provide for a response to the emergency communications by the recipient computing device in a manner that is consistent with that computing device's capabilities. The emergency notification system 250 can interface with the operating system APIs 260 to provide such a response.

Turning back to FIG. 1, the exemplary computing device 100 of FIG. 2 can take the form of a portable computing device 62, such as, for example, a laptop, palmtop, or mobile Internet device (MID), a telephonic computing device 63, such as, for example, a cellular telephone or a smartphone, a fixed computing device 64, such as, for example, a desktop personal computer, a server, or a network storage unit, or the exemplary computing device can take the form of a display computing device 65, such as, for example, a television, a monitor, or a smart display. For each type of computing device, of which computing devices 62, 63, 64 and 65 are merely examples, the operating system 134 and, in particular, the operating system APIs 260, can define the relevant capabilities of that computing device. Consequently, in one embodiment, the emergency notification system 250 can be a uniform system across multiple types of operating systems, and can discover the relevant capabilities of a computing device after installation thereon. In an alternative embodiment, the emergency notification system 250 can be customized for a particular device or a particular operating system 134. In either embodiment, the emergency notification system 250 can tailor its response to an emergency communication to the capabilities of the computing device.

For example, for computing devices that are likely to be continuously interacting with one or more users, such as the portable computing device 62 and the fixed computing device 64, the receipt, by the emergency notification system 250 of an emergency communication via one of the reserved communication channels described can initiate processing whereby the emergency notification system instructs the operating system 134 to display an appropriate message via any display devices connected to the portable computing device 62 and the fixed computing device 64. Such a message can, as indicated previously, comprise a simple collection of untailored information, such as a brief description of the emergency, and a floor plan indicating the location of building services that may be relevant to the given emergency. In another embodiment, because computing devices 62 and 64 are likely to be in use when an emergency notification arrives, the emergency notification system can further instruct the operating system 134, via the operating system APIs 260, to enter a “safe state” or other appropriate state whereby the useful processing being performed by the computing device can be saved to non-volatile memory, thereby preserving it, while at the same time encouraging the user to evacuate, or otherwise minimize their risk, rather than continuing to utilize the computing device.

As another example, for computing devices that may provide more simplified computational capabilities, such as the telephonic computing device 63 or the display computing device 65, the emergency notification system 250 can instruct the operating system 134 of such devices to simply display a relevant message and, if possible, relevant information regarding the affected area. Thus, for example, a display computing device 65 can be caused, by the emergency notification system 250, to display a static message regarding the emergency, together with a building floor plan, while a telephonic computing device 63 may simply display a short text message. In each case, capabilities unique to each computing device can likewise be utilized by the emergency notification system 250. For example, the telephonic computing device 63 can be caused to vibrate or otherwise signal the user, while the display computing device 65 may be able to broadcast a sufficiently detailed audio signal to provide spoken commands.

Because the emergency notification system 250 can be part of, or otherwise integrated with, the operating system 134, it can be provided with the ability to cause the associated computing device 100 to perform actions that may otherwise require a level of privilege that the operating system may not readily provide to, for example, an application, such as application 270. Appropriate security measures can be implemented to provide protection against malicious use of such privilege. Nevertheless, given the limited, and emergency-based nature of the execution of the instructions of the emergency notification system 250, such a level of privilege may be warranted.

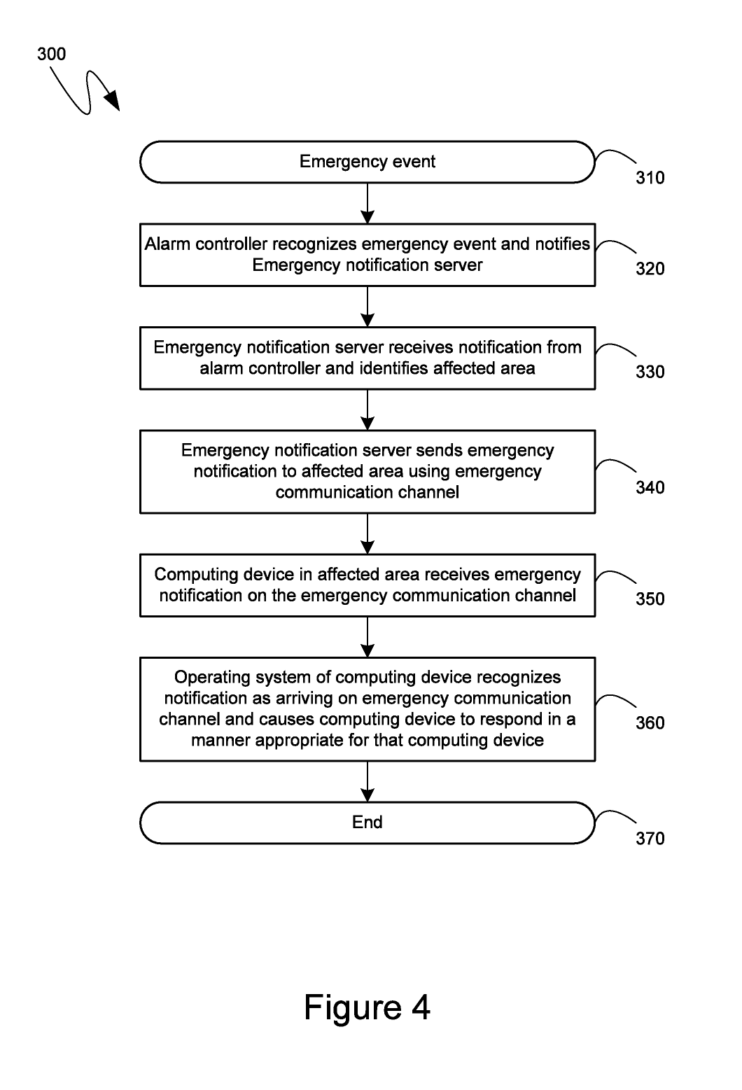

Turning to FIG. 4, a flow diagram 300 is shown, illustrating an exemplary series of steps by which a communication channel reserved for emergency notifications can be utilized to provide such notifications to those at risk of harm by the emergency. As illustrated, an emergency event 310 can initiate the flow diagram 300. Subsequently, after the emergency event at step 310 affects one or more of the sensors of the alarm system, the alarm controller 10 can, at step 320, recognize the existence of the emergency event and can notify the emergency notification server 30.

Upon receiving an indication of an emergency event from the alarm controller 10, the emergency notification server 30 can, at step 330, identify the physical area affected by the emergency and can, thereby, identify the computing devices to which an emergency notification is to be directed. At step 340, the emergency notification server 30 can transmit, to the identified computing devices, an emergency notification utilizing the above-described reserved emergency communication channels. In one embodiment, the identified computing devices need not be identified specifically, but rather merely as members of an identified group, such as by a range of network identifiers. The emergency notification can be received by the target computing devices at step 350 and provided to the emergency notification system component 250.

The emergency notification system 250 can, at step 360, and as described above, instruct the computing device upon which it is executing to display an emergency notification in a manner appropriate for that computing device. Thus, for more traditional personal computers, a “safe mode” can be requested, whereby emergency information can be conveyed to the user while protecting the user's work and, simultaneously, removing the temptation for the user to remain to complete processing, as opposed to evacuating or otherwise mitigating the risk introduced by the emergency. Alternatively, for more computationally simpler devices, a simple notification can be instructed, by the emergency notification system 250, to be displayed. Having delivered the emergency notification, the relevant processing can end at step 370, as indicated in FIG. 4.

As can be seen from the above descriptions, an emergency notification system utilizing communicational channels reserved for emergency communications can be integrated into, or associated with, the operating system of a computing device to enable the computing device to provide emergency notifications. In view of the many possible variations of the subject matter described herein, we claim as our invention all such embodiments as may come within the scope of the following claims and equivalents thereto.

We claim:

1. One or more computer-readable media comprising computer-executable instructions providing an operating system for a computing device, the computer-executable instructions directed to steps comprising:
identifying data received through a network connection as associated with a network communication channel reserved for emergency notifications;
in response to the identifying, providing the received data to an emergency notification system component of the operating system; and
causing the computing device to display emergency-related information in a manner appropriate for the computing device.

2. The computer-readable media of claim 1, wherein the network communication channel reserved for emergency notifications is a TCP/IP port.

3. The computer-readable media of claim 1, wherein the network communication channel reserved for emergency notifications comprises messages that are associated with emergency-identifying information, and that are transmitted via a messaging protocol.

4. The computer-readable media of claim 1, wherein the display of emergency-related information in a manner appropriate for the computing device comprises the presentation of general building information identifying building services relevant to an emergency associated with the received data.

5. The computer-readable media of claim 1, wherein the display of emergency-related information in a manner appropriate for the computing device comprises the placing, of the computing device, into a safe state providing non-volatile storage of a current state and preventing additional user interaction.

6. A method of providing emergency notifications comprising the steps of:
receiving information comprising an identification of an emergency and a location of the emergency;
identifying an affected area associated with the emergency and informed by the location of the emergency;
identifying affected computing devices based on network identifiers that correspond to the affected area and that were previously assigned to the affected computing devices in accordance with the affected computing devices' locations;
transmitting, to the affected computing devices, an emergency notification message via a network communication channel reserved for emergency notifications;
providing, at each affected computing device, the emergency notification message to an emergency notification system of the each affected computing device's operating system; and
causing the each affected computing device to display information associated with the emergency in a manner appropriate for the each affected computing device.

7. The method of claim 6, wherein the network communication channel reserved for emergency notifications is a TCP/IP port.

8. The method of claim 6, wherein the network communication channel reserved for emergency notifications comprises messages that are associated with emergency-identifying information, and that are transmitted via a messaging protocol.

9. The method of claim 6, wherein the display of the information associated with the emergency in a manner appropriate for the each affected computing device comprises the presentation of general building information identifying building services relevant to the emergency.

10. The method of claim 6, wherein the display of the information associated with the emergency in a manner appropriate for the each affected computing device comprises the placing, of the computing device, into a safe state providing non-volatile storage of a current state and preventing additional user interaction.

11. The method of claim 6, wherein the network identifiers corresponding to the affected area comprise a predetermined range of network identifiers.

12. A system for providing emergency notifications comprising:
an emergency notification server comprising a communicational connection to an alarm system, a communicational connection to a building services information repository, a communicational connection to at least one affected computing device, and a processing unit for utilizing emergency data that is associated with an emergency and that was received from the alarm system and information that was received from the building services information repository to identify the at least one affected computing device affected by the emergency, and for utilizing the communicational connection to the at least one affected computing device to transmit an emergency notification utilizing a network communication channel reserved for emergency notifications; and
at least one affected computing device comprising an operating system comprising an emergency notification system, the operating system recognizing the emergency notification as such based its transmission via the network communication channel reserved for emergency notifications, and the emergency notification system causing the at least one affected computing device to display emergency-related information in a manner appropriate for the at least one affected computing device in response to the emergency notification.

13. The system of claim 12, wherein the network communication channel reserved for emergency notifications is a TCP/IP port.

14. The system of claim 12, wherein the network communication channel reserved for emergency notifications comprises messages that are associated with emergency-identifying information, and that are transmitted via a messaging protocol.

15. The system of claim 12, wherein the display of emergency-related information in a manner appropriate for the at least one affected computing device comprises the presentation of general building information identifying building services relevant to the emergency.

16. The system of claim 12, wherein the display of emergency-related information in a manner appropriate for the at least one affected computing device comprises the placing, of the at least one affected computing device, into a safe state providing non-volatile storage of a current state and preventing additional user interaction.

17. The system of claim 12, wherein the emergency notification server further comprises a processing unit for identifying, based on the emergency data and the information received from the building services information repository, an affected area affected by the emergency; and wherein the identification of the at least one affected computing device comprises identifying the at least one affected computing device based on a network identifier, corresponding to the affected area, and assigned to the at least one affected computing device.

18. The system of claim 17, wherein the network identifiers corresponding to the affected area comprise a predetermined range of network identifiers.
